(19) United States
(12) Patent Application Publication
(10) Pub. No.: US 2012/0268190 A1
(43) Pub. Date: Oct. 25, 2012

(54) LOCAL OSCILLATOR CLOCK SIGNALS

(75) Inventors: Abdellatif Bellaouar, Richardson, TX (US); See Taur Lee, Allen, TX (US)

(73) Assignee: Icera Inc., Wilmington, DE (US)

(21) Appl. No.: 13/089,832

(22) Filed: Apr. 19, 2011

(51) Int. Cl. G06G 7/12

(52) U.S. Cl. 327/355

(57) ABSTRACT

An apparatus and method for generating complementary periodic signals for a mixer circuit is provided. The apparatus comprises first and second generation circuits each for generating a periodic signal with a transition time on each rising edge different than a transition time on each falling edge. Each of the first and second generation circuits has an output for supplying its periodic signal to a mixer such that each rising edge of a periodic signal from one of the circuits crosses each falling edge of a periodic signal from the other of the circuits at a crossing point below a turn on voltage of the mixer.

### TECHNICAL FIELD

This invention relates to a mixer for frequency up-conversion in a transceiver and to a circuit for providing a local oscillator clock signal therefore.

### BACKGROUND

Wireless devices have been in use for many years for enabling mobile communication of voice and data. Such devices can include mobile phones and wireless enabled personal digital assistants (PDA's) for example. FIG. 1 is a generic block diagram of the core components of such wireless devices. The wireless core 10 includes a base band processor 12 for controlling application specific functions of the wireless device and for providing and receiving voice or data signals to a radio frequency (RF) transceiver chip 14. The RF transceiver chip 14 is responsible for frequency up-conversion of transmission signals, and frequency down-conversion of received signals. RF transceiver chip 14 includes a receiver core 16 connected to an antenna 18 for receiving transmitted signals from a base station or another mobile device, and a transmitter core 20 for transmitting signals through the antenna 18 via a gain circuit 22. Those of skill in the art should understand that FIG. 1 is a simplified block diagram, and can include other functional blocks that may be necessary to enable proper operation or functionality.

Generally, the transmitter core 20 is responsible for up-converting electromagnetic signals from baseband to higher frequencies for transmission, while receiver core 16 is responsible for down-converting those high frequencies back to their original frequency band when they reach the receiver, processes known as up-conversion and down-conversion, respectively. The original (or baseband) signal may be, for example, data, voice or video. These baseband signals may be produced by transducers such as microphones or video cameras, be computer generated, or transferred from an electronic storage device. In general, the higher frequencies provide longer range and higher capacity channels than the baseband signals.

FIG. 2 illustrates an example transmit path through the transmitter core 20 to the antenna 18. As shown in FIG. 2, the transmit path may include a mixer 202 arranged to receive baseband signals from the baseband processor 12. The mixer is responsible for up-converting the baseband signals to a higher frequency using a local oscillator signal generated by a local oscillator 204. The transmit path may further include a filter 206 for removing baseband components and suppressing harmonics and a power amplifier 208 for amplifying power of the modulated signal. The components in the transmit path are not comprehensive and any person of skill in the art will understand that the specific configuration will depend on the communication standard being adhered to and the chosen architecture implementation.

A known passive CMOS (complementary-symmetry metal-oxide-semiconductor) mixer circuit 300 will now be described with reference to FIG. 3. The baseband signals are analog signals generated by modulating a baseband carrier with data, in accordance with any known protocol.

The CMOS passive mixer circuit 300 may receive differential baseband signals (VBBP, VBBM) from a baseband processor. The term ‘differential’ is used here to describe that the baseband signals (VBBP, VBBM) are substantially in opposite phase to each other, i.e., 180 degrees out of phase. The mixer circuit 300 includes n-type metal oxide semiconductor field effect (NMOS) transistors 302, 304, 306, and 308 that are arranged to receive the baseband signals VBBP and VBBM and are clocked by differential local oscillator signals (VLOP, VLOM). The NMOS transistors 302, 304, 306, and 308 provide differential outputs VOP and VOM.

Whilst the CMOS passive mixer circuit 300 has been described with respect to NMOS transistors, those skilled in the art will understand that transistors 302, 304, 306, and 308 may be selected to be p-type metal oxide semiconductor field effect (PMOS) transistors.

In operation, the mixer circuit 300 up-converts the baseband signals (VBBP, VBBM) to a desired RF transmit frequency using the local oscillator signals (VLOP, VLOM). For the passive mixer 300 to operate, the baseband signals are required to drive the passive mixer that has a load at the output with minimum distortion. Any distortion from the baseband processor will degrade the linearity of the passive mixer circuit 300.

One of the known protocols for RF signaling uses complex in-phase (I) and quadrature phase (Q) signals, where each can be in differential formats. International Publication WO 2010/025556 discloses an IQ passive mixer 400 which will now be described with reference to FIG. 4.

The differential baseband input signals for the I and Q paths are labeled VBBQP, VBBQM, VBBIP, and VBBIM. The passive IQ mixer 400 comprises NMOS transistors 402, 404, 406, 408, 410, 412, 414, 416 for the I/Q paths which are clocked by the appropriate LO signals VLOIP, VLOIM, VLOQP, and VLOQM where the LO signals are differential signals having I and Q components.

The differential outputs of the passive IQ mixer 400, namely VOP and VOM, are voltage outputs that may later drive an amplifier, for example power amplifier 208 through ac-coupling capacitors (not shown in FIG. 4).

The LO signal (VLOIP, VLOIM, VLOQP, and VLOQM) is a square waveform from 0V to 1.2V and is designed to have low rise and fall times. This arrangement enables the omission of surface acoustic wave (SAW) filters that are traditionally used at the transmitter's output. Accordingly, this helps to minimize the number of required external components, the required board area, and hence reduces the overall cost of the chip.

The local oscillator signals typically applied to the IQ passive mixer 400 over a time period comprising time slots 1 to 8 are shown in FIG. 5. As shown in FIG. 5, local oscillator signals VLOIP and VLOIM both have a 50% duty cycle and are substantially in opposite phase to each other, i.e., 180 degrees out of phase. Similarly, VLOQP and VLOQM both have a 50% duty cycle and are substantially in opposite phase to each other, i.e., 180 degrees out of phase. The local oscillator signals VLOQP, VLOQM on the Q path lag the local oscillator signals VLOIP, VLOIM on the I path by 90 degrees.

The local oscillator signals VLOIP and VLOIM and also VLOQP and VLOQM in FIG. 5 normally cross at the midpoint of the power supply. During the crossing point, there is a short period of time at the outputs VOP, VOM when VBBQP and VBBQM or VBBQP and VBBIM are shorted together.

This can be seen for example between time slots 1 and 2 when the VLOIP oscillator signal is rising from a ‘low’ state to ‘high’ state and the VLOIM local oscillator signal is falling from a ‘high’ state to a ‘low’ state. Referring back to the IQ passive mixer 400 shown in FIG. 4, during the transitions of the VLOIP and VLOIM local oscillator signals, there will be a short period of time where the transistors 402, 404, 406, and 408 will all be turned on. Therefore the baseband input signals VBBQP and VBBQM will be shorted together at the output VOP and at the output VOM. This reduces the gain and creates distortion at the output signals VOP, VOM and eventually degrades the linearity of the CMOS passive mixer.

It is an aim of the present invention to provide a solution to the above mentioned problems of achieving a highly linear CMOS passive mixer.

### SUMMARY

According to one aspect of the invention there is provided an embodiment of an apparatus for generating complementary periodic signals for a mixer circuit. The apparatus comprises first and second generation circuits. Each of the first and second generation circuits generate a periodic signal with a transition time on each rising edge different than a transition time on each falling edge. Each circuit has an output for supplying its periodic signal to a mixer such that each rising edge of a periodic signal from one of the circuits crosses each falling edge of a periodic signal from the other of the circuits at a crossing point below a turn on voltage of the mixer.

Another aspect of the invention provides an embodiment of a method of generating complementary periodic signals for a mixer. The method comprises generating first and second periodic signals, supplying the first periodic signal at a first output for connection to the mixer, and supplying the second periodic signal at a second output for connection to the mixer. Each of the first and second periodic signals are generated with a transition time on each rising edge different than a transition time on each falling edge, from each of a first and second generation circuit. The second periodic signal is supplied at the second output for connection to the mixer such that each rising edge at the first output is timed to cross each falling edge at the second output at a crossing point below a turn on voltage of the mixer.

A further aspect of the invention provides an embodiment of a CMOS passive mixer comprising a first and second transistor. The CMOS passive mixer further comprises first and second generation circuits, each for generating a periodic signal with a transition time on each rising edge different than a transition time on each falling edge. Each circuit has an output for supplying its periodic signal to a mixer such that each rising edge of a periodic signal from one of the circuits crosses each falling edge of a periodic signal from the other of the circuits at a crossing point below a turn on voltage of the mixer. The periodic signal from the first generation circuit controls the first transistor and the periodic signal from the second generation circuit controls the second transistor such that only one of the first and second transistors is turned on at any one time.

### BRIEF DESCRIPTION OF THE DRAWINGS

For a better understanding of the present invention and to show how the same may be put into effect, reference will now be made, by way of example, to the following drawings in which:

FIG. 1 is block diagram of a wireless core of the prior art;

FIG. 2 is a block diagram of transmitter core of a wireless core shown in FIG. 1;

FIG. 3 is a circuit diagram of a passive CMOS mixer circuit of the prior art;

FIG. 4 is a circuit diagram of an IQ mixer circuit according to the prior art;

FIG. 5 illustrates the typical local oscillator signals that are applied to the circuit of FIG. 4;

FIG. 6 is a circuit diagram of a circuit for generating a local oscillator signal according to an embodiment of the invention;

FIG. 7 illustrates how a local oscillator signal may be generated using the circuit of FIG. 6;

FIG. 8 illustrates local oscillator signals that may be generated using circuits shown in FIG. 6;

FIG. 9 is a circuit diagram of an IQ mixer circuit and a driver circuit according to the prior art;

FIG. 10 is a circuit diagram of a driver circuit that may be used in conjunction with circuit of FIG. 6; and

FIG. 11 is a circuit diagram of a section of a prior art IQ passive mixer circuit showing how driver circuits shown in FIG. 10 may be used in conjunction with circuits of FIG. 6.

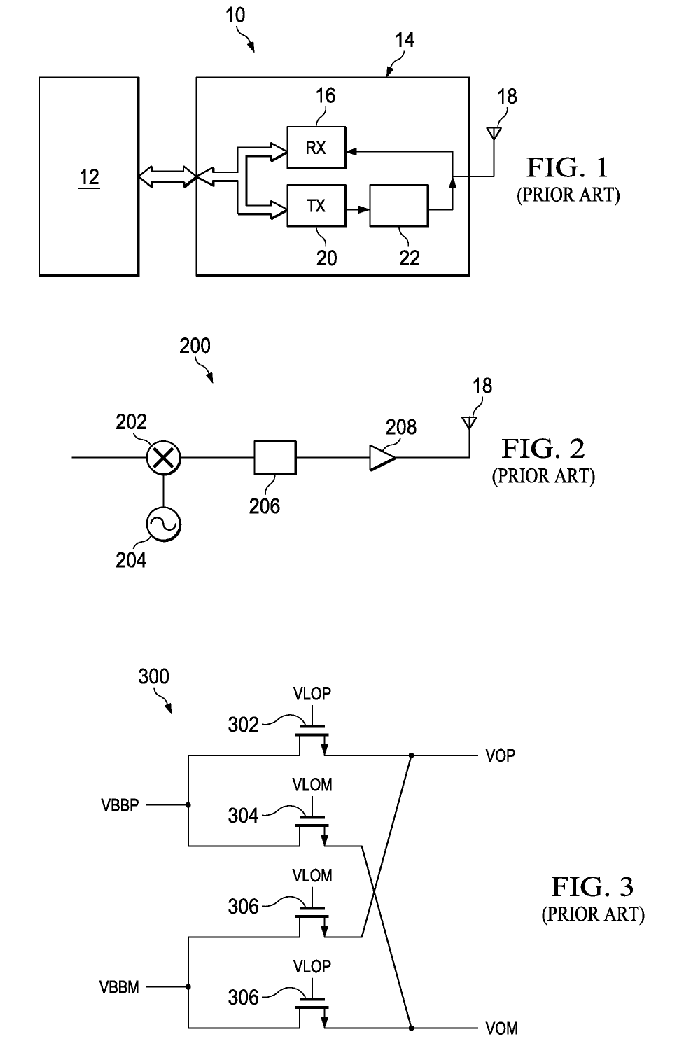

### DETAILED DESCRIPTION

A circuit for generating local oscillator signals according to an embodiment of the present invention will now be described with reference to FIG. 6. As shown in FIG. 6, local oscillator signal generation circuit 600 comprises two CMOS inverters connected in series. A first CMOS inverter includes a pull-up PMOS transistor 602 connected in series with a pull-down NMOS transistor 604. The gate terminals of PMOS transistor 602 and NMOS transistor 604 are connected together and receive an input signal VIN on line 601. The input signal is a periodic signal with a 50% duty cycle, oscillating between high and low states at a desired frequency. The frequency of the input signal VIN is chosen in dependence on the desired frequency of the local oscillator output. The source terminal of the PMOS transistor 602 is connected to the supply voltage AVDD, the source terminal of the NMOS transistor 604 is connected to the supply voltage AVSS, and the drain terminals of the PMOS transistor 602 and NMOS transistor 604 are connected together to provide an output Vm of the first CMOS inverter on line 611. AVDD may be 1.2V and AVSS may be 0V, however it will be appreciated that other values of the supply voltages may be selected.

A second CMOS inverter includes a pull-up PMOS transistor 606 connected in series with a pull-down NMOS transistor 608. The gate terminals of PMOS transistor 606 and NMOS transistor 608 are connected together and receive the output Vm of the first CMOS inverter on line 611. The source terminal of the PMOS transistor 606 is connected to the supply voltage AVDD, the source terminal of the NMOS transistor 608 is connected to the supply voltage AVSS, and the drain terminals of the PMOS transistor 606 and NMOS transistor 608 are connected together to provide an output VOUT in the form of a local oscillator signal on line 621.

The transistor sizes (i.e., channel width or channel length) of transistors 602, 604, 606, and 608 have been selected in order to control the rise and fall times of the local oscillator signal VOUT generated by the circuit 600 relative to the input signal VIN. The PMOS transistor 602 may be sized relative to NMOS transistor 604 such that the PMOS transistor 602 provides a fast pull up to the AVDD voltage supply rail. Similarly, the NMOS transistor 608 may be sized relative to PMOS transistor 606 such that the NMOS transistor 608 provides a fast pull down to the AVSS voltage supply rail.

So that the PMOS 602 provides a fast pull up to AVDD, the pull-up PMOS transistor 602 may have a larger channel width than the NMOS transistor 604 or a smaller channel length than the NMOS transistor 604. So that the NMOS transistor 608 provides a fast pull down to the AVSS, the pull-down NMOS transistor 608 may have a larger channel width than the PMOS transistor 606 or a smaller channel length than the PMOS transistor 606.

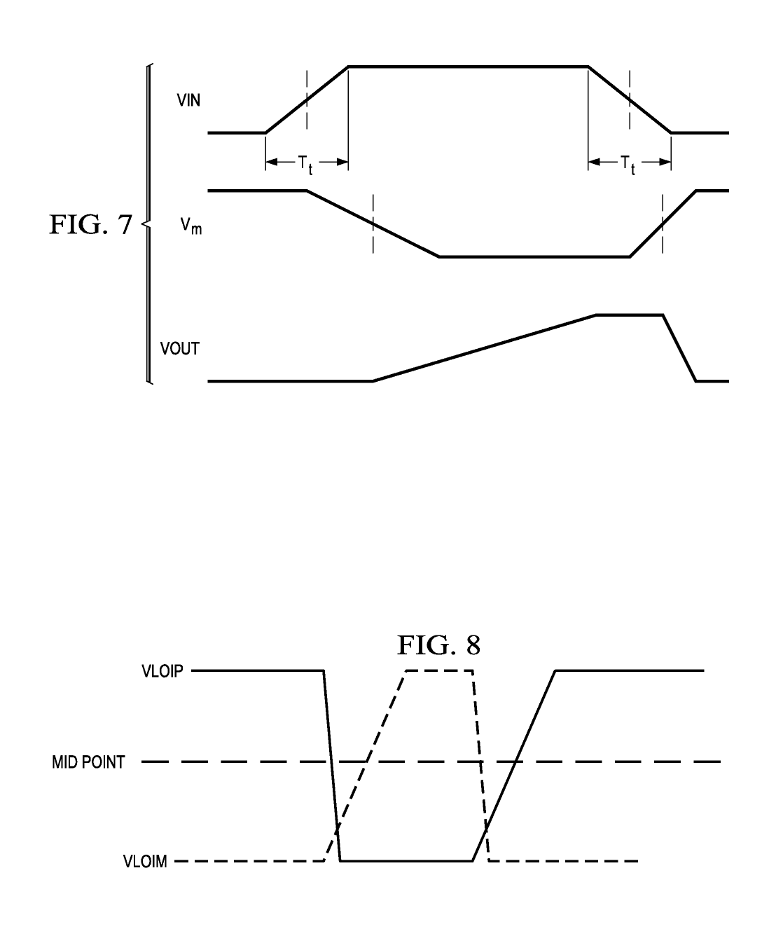

The effect of sizing the PMOS transistor 602 and the NMOS transistor 608 in the circuit 600 as described above will now be described with reference to FIG. 7. FIG. 7 illustrates the rise and fall times of the signal Vm on line 611 and the output signal VOUT on line 621 when an input signal VIN is received on the input line 601. As will be appreciated by those skilled in the art the input signal VIN on input line 601 may not have “ideal” transitions, but is likely to have a transition time Tt between low and high states which is greater than zero.

As the input signal VIN makes a transition from low to high, the gate source voltage of PMOS transistor 602 decreases while the gate to source voltage of NMOS transistor 604 increases. The NMOS transistor 604 starts to turn on and the PMOS transistor 602 starts to turn off, pulling the output of the first CMOS inverter on line 611 towards AVSS. Initially, however, the pulling of the output on line 611 towards AVSS by the relatively weaker NMOS transistor 604 is resisted by the relatively stronger PMOS transistor 602 that is not yet completely off. This results in a slow fall time of the signal Vm on line 611.

When the signal Vm on line 611 falls from high to low, PMOS transistor 606 is turned on and the NMOS transistor 608 is off. The pulling of the output line 621 towards AVDD by the relatively weaker PMOS transistor 606 is resisted by the relatively stronger NMOS transistor 608. This results in a slow rise time of the output signal VOUT on line 621.

When the input signal VIN makes a transition from high to low, the gate source voltage of PMOS transistor 602 increases while the gate to source voltage of NMOS transistor 604 decreases. The NMOS transistor 604 starts to turn off and the PMOS transistor 602 starts to turn on, pulling the output of the first CMOS inverter on line 611 towards AVDD. Initially, however, in pulling the output on line 611 towards AVDD by the relatively weaker NMOS transistor 604 is resisted by the relatively stronger PMOS transistor 602 that is not yet completely off. This results in a fast rise time of the signal Vm on line 611.

When the signal Vm on line 611 makes a transition from low to high, PMOS transistor 606 is turned off and the NMOS transistor 608 is on. The pulling of the output line 621 towards AVSS by the relatively stronger NMOS transistor 608 is resisted by the relatively weaker PMOS transistor 606. This results in a fast fall time of the signal VOUT on line 621.

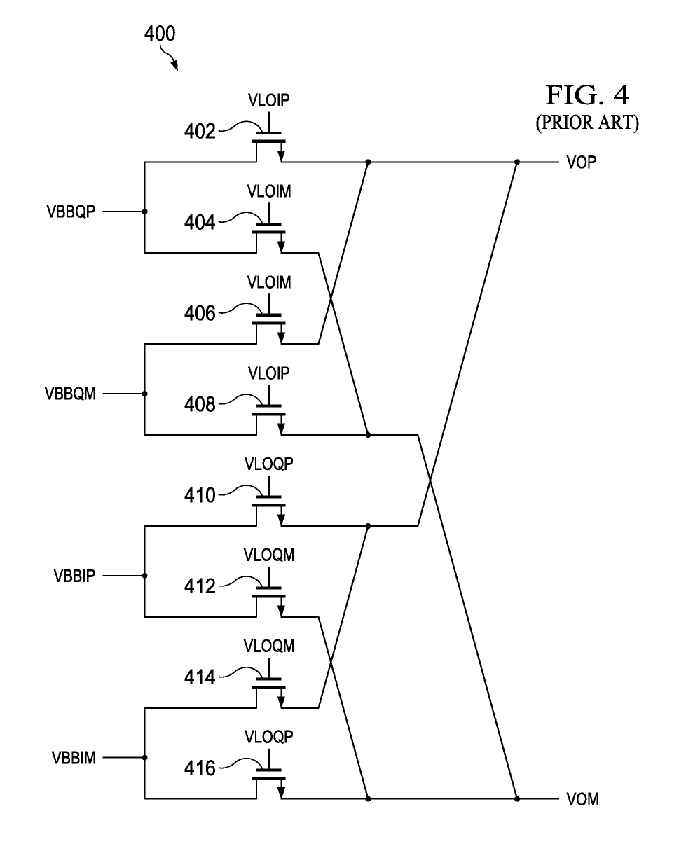

The local oscillator on output line 621 is shown in FIG. 8 and is labeled ‘VLOIM’. A replica circuit to circuit 600 may generate the local oscillator signal VLOIP (also shown in FIG. 8) when the replica circuit receives an input clock signal VIN that is in opposite phase to the input clock signal that is received on the input line 601. The local oscillator signals VLOIP and VLOIM may be supplied to a passive mixer circuit such as the IQ passive mixer 400 shown in FIG. 4.

It will be appreciated that a circuit 600 and replica circuit may also generate the local oscillator signals VLOQP and VLOQM and that VLOQP and VLOQM will have the same shape as, but will lag by 90 degrees, the waveforms shown in FIG. 8. As shown in FIG. 8, the sizing of transistors 602, 608 has been selected such that local oscillator signals VLOIP and VLOIM do not cross at the midpoint of the power supply. Therefore, when the local oscillator signal VLOIP is supplied to transistor 402 and the local oscillator signal VLOIM is supplied to transistor 404 of the IQ passive mixer 400, only one of the transistors 402, 404 is switched on at any one time. This prevents the baseband input signals VBBQP and VBBQM from being shorted together at the outputs VOP, VOM. Thus, the present invention avoids the degradation of the linearity of the CMOS passive mixer caused by the shorting of the baseband input signals.

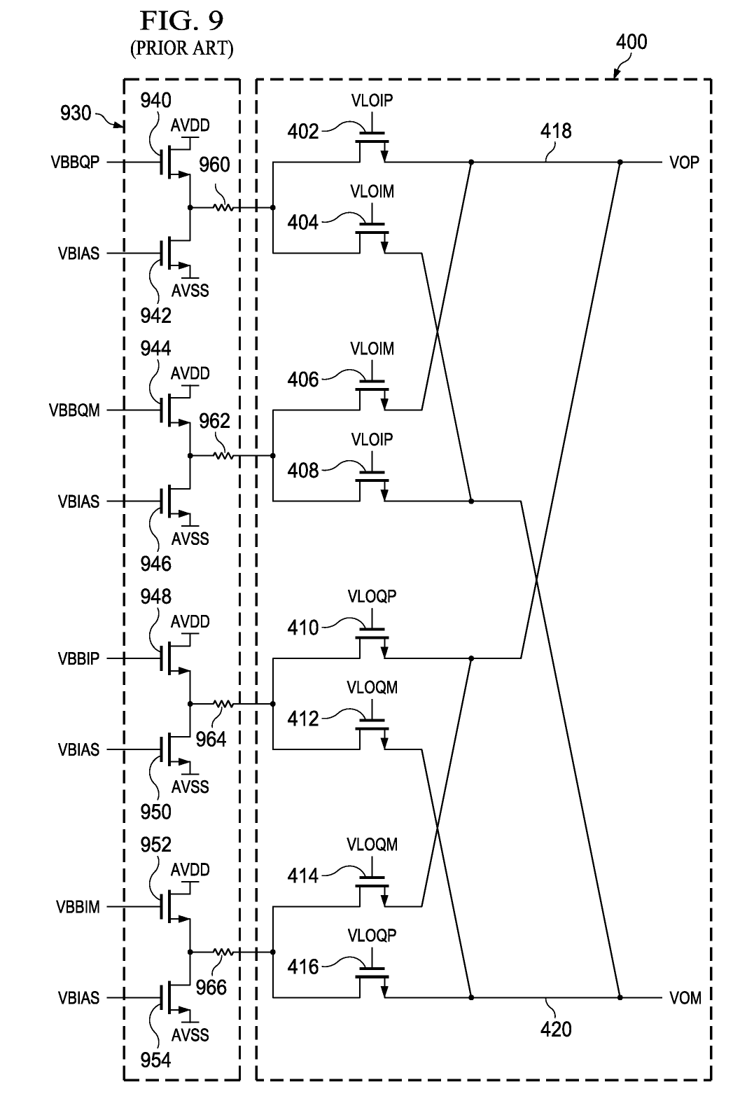

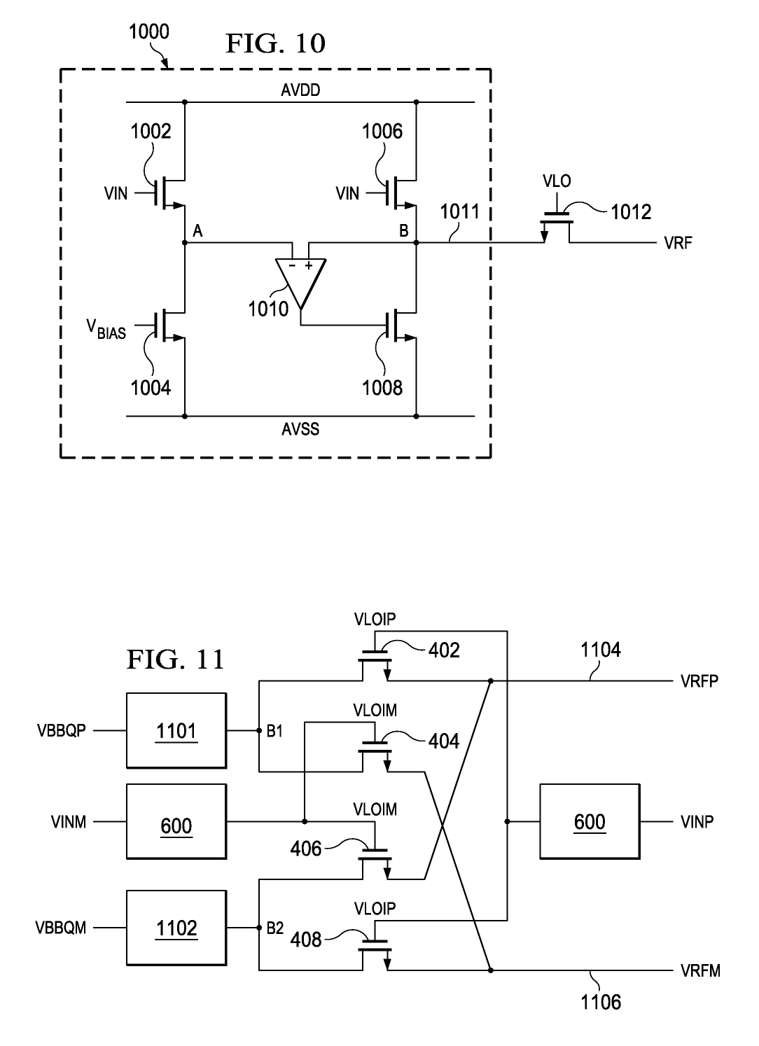

The circuit can be used to particular advantage in the context of a mixer circuit as described with reference to FIGS. 9 and 10. International Publication WO 2010/025556 discloses an IQ passive mixer 400 (as shown in FIG. 4) with driver circuitry 930 which will now be described with reference to FIG. 9.

The differential baseband input signals for the I and Q paths are labelled VBBQP, VBBQM, VBBIP, and VBBIM. These baseband input signals are input into the driver circuitry 930. The driver circuitry 930 comprises source follower NMOS transistors 940, 944, 948 and 952 connected to bias NMOS transistors 942, 946, 950 and 954. The gate terminals of source follower NMOS transistors 940, 944, 948 and 952 receive the baseband input signals VBBQP, VBBQM, VBBQP, and VBBIM. The gate terminals of bias NMOS transistors 942, 946, 950, and 954 receive a bias voltage VBIAS. The outputs of the source follower NMOS transistors 942, 946, 950, and 954 are passed through resistors 960, 962, 964, 966 before being provided to the IQ passive mixer 400.

For a mixer performing an up-conversion frequency translation, a typical specification used is called FRF-3BB (Delta). This is the ratio of the up-converted RF signal to the third order distortion, where the third order distortion is F_{LO}-3.F_{BB} (F_{LO} is the local oscillator frequency and F_{BB} is the frequency of the baseband input signal). For a 2 G application, a typical Delta of 55 dB is required. For a 3 G voice application, a typical Delta of 45 dB is required.

Thus, to have high Delta, the source follower NMOS transistors 940, 944, 948, and 952 shown in FIG. 9 are required to have large transconductance (gm). The transconductance (gm) for a source follower transistor is directly proportional to the drain current I_{D} of the source follower transistor. Therefore, in order to achieve a high delta value, the current consumption of the source follower transistor must also increase.

The transconductance gm varies with the baseband input signal, due to resulting variations in the drain current. To minimize the effect of the variations, additional resistors 960, 962, 964, and 968 are added in series with the inherent (1/gm) resistance of the source follower NMOS transistors 940, 944 to 948, and 952 to improve the linearity of the IQ passive mixer 400.

One trade-off with this design is the value of the resistance of resistors 960, 962, 964, 966 and the Delta value. With a high resistor value, the delta value increases however the SNR decreases. Similarly, with a low value resistor the SNR increases however the delta value decreases.

FIG. 10 shows an alternative driver circuit 1000 that may be used to provide a baseband input signal to a transistor of the IQ passive mixer circuit 400.

As shown in FIG. 10, driver circuit 1000 comprises a source follower NMOS transistor 1002 connected in series with bias NMOS transistor 1004 such that the drain terminal of transistor 1002 is connected to a supply voltage AVDD, the source terminal of transistor 1002 is connected to the drain terminal of transistor 1004 at node A, and the source terminal of transistor 1004 is connected to a supply voltage AVSS. The supply voltage AVSS may be 0V. The gate terminal of transistor 1002 receives a baseband input signal VIN. The gate terminal of transistor 1004 receives a direct-current (DC) bias voltage input signal VBIAS.

Driver circuit 1000 further comprises a source follower NMOS transistor 1006 connected in series with a transistor 1008 such that the drain terminal of transistor 1006 is connected to the supply voltage AVDD, the source terminal of transistor 1006 is connected to the drain terminal of transistor 1008 at node B, and the source terminal of transistor 1008 is connected to the supply voltage AVSS. The gate terminal of transistor 1006 receives the baseband input signal VIN. The baseband input signal VIN may be one of the differential baseband input signals VBBQP, VBBQM, VBBIP or VBBIM.

Node A is connected to the inverting input of an operational amplifier 1010. Node B is connected to the non-inverting input of the operational amplifier 1010. The output of operational amplifier 1010 is connected to the gate terminal of transistor 1008. Node B further provides the output of the driver circuit 1000 on line 1011. As shown in FIG. 10, the baseband input signal VIN may be supplied on line 1011 to a transistor 1012 which is part of a CMOS passive mixer circuit for example an IQ passive mixer 400 as shown in FIG. 9.

It will be appreciated that four of the driver circuits 1000 will be required in order to supply each of the baseband input signals VBBQP, VBBQM, VBBIP, or VBBQM to the IQ passive mixer 400.

Referring to both FIGS. 9 and 10, driver circuits 1000 may replace the source follower NMOS transistor, bias NMOS transistor, and resistor of the driver circuitry 930 on each I and Q path. For example, the source follower NMOS transistor 940, bias NMOS transistor 942, and the resistor 960 may be replaced by the driver circuit 1000 wherein the source follower NMOS transistor 1002 would receive the baseband input signal VBBQP at its gate terminal.

In the driver circuitry 930 shown in FIG. 9, due to the direct-current (DC) bias voltage input signal VBIAS, the bias NMOS transistors 942, 946, 950, 954 are constant current sources which, because they receive a constant bias voltage, sink a constant current.

In operation of the driver circuit 1000 the operational amplifier 1010 is used to copy node voltage A to node B by controlling the gate terminal of transistor 1008. The output voltage at node B is then used to drive transistor 1012 in the CMOS passive mixer circuit directly. The source follower NMOS transistor 1006, transistor 1008, and operational amplifier 1010 act like a class-AB driver driving the passive mixer in the sense that the length of time (proportion of the input signal) during which current flows through the transistor 508 is around 50%. The source follower NMOS transistor 1006 acts to source AC current into the transistor 1012 and transistor 1008 is used to sink AC current from transistor 1012.

This has advantages over the source follower discussed above with a constant current source, because the constant current source can only sink a constant current and is thus required to be biased at high current to ensure linearity during operation.

In the driver circuit 1000, the bias NMOS transistor 1004 controls the bias current of transistor 1002. The voltage at node A is not used to drive a transistor of the CMOS passive mixer, but instead sees the high impedance of the op-amp. The voltage at node B, which has been copied from the voltage at node A using the operational amplifier 1010, is used to drive a transistor of the CMOS passive mixer. The transistor 1008 does not receive a direct-current (DC) bias voltage input signal VBIAS at its gate terminal, but the output of the op-amp, which is of a varying magnitude of voltage. The magnitude of voltage at the output of the operational amplifier 1010 varies in dependence on the input signal and the amount of DC current flowing through transistor 1008. The higher the DC current the better the linearity you get from the source follower transistor 1006.

Note that since a resistor (i.e., one of resistors 460, 462, 464, 468 described with reference to FIG. 4) is not required in this case, no trade-off between linearity and SNR is required. Furthermore since the source follower transistor 502 output (node A) does not need to drive the CMOS passive mixer with a load directly, the passive mixer circuit can achieve very high linearity.

In the driver circuit 1000, the bias NMOS transistor 1004 is a constant current source which sinks a constant current; however, the voltage at node A is not used to drive a transistor of the CMOS passive mixer. Instead the voltage at node B, which has been copied from the voltage at node A using the operational amplifier 1010, is used to drive a transistor of the CMOS passive mixer. The transistor 1008 is not a constant current source therefore less current is drawn during operation of the driver circuitry than the prior art driver circuitry disclosed in WO 2010/025556.

According to one embodiment of the present invention, four local oscillator signal generation circuits 600 are used to supply the local oscillator signals VLOIP, VLOIM, VLOQP, and VLOQM, respectively, to the IQ passive mixer circuit 400 that receives baseband input signals through four driver circuits 1000.

FIG. 11 illustrates the top half of the IQ passive mixer circuit 400 which receives the baseband input signals VBBQP and VBBQM through driver circuits 1101 and 1102 and receives local oscillator signals VLOIP and VLOIM (as shown in FIG. 8). Driver circuits 1101 and 1102 are equivalent to the driver circuit 1000 shown in FIG. 10.

The local oscillator signal VLOIP generated by a local oscillator signal generation circuit 600 is supplied to the gate terminal of transistors 402 and 408. The local oscillator signal VLOIM generated by another local oscillator signal generation circuit 600 is supplied to the gate terminal of transistors 404 and 406. This arrangement guarantees that the transistors 402, 408 are not switched on at the same time as transistors 404, 406.

As a result, the baseband signals VBBQP and VBBQM will be prevented from shorting on the output line 1104 and on the output line 1106. For example, when the transistor 402 is turned on the baseband input signal VBBQP that has passed through driver circuit 1101 is supplied at node B1 and is unconverted to a higher frequency signal VRFP on line 1104 (note that node B1 is a copy of VBBQP because transistor 1002 and 1006 in the driver circuit 1101 are source followers). In this arrangement, the transistor 406 is turned off thereby preventing the baseband input signal VBBQM that has passed through driver circuit 1102 to node B2 from shorting with the signal VRFP. When the transistor 408 is turned on, the baseband input signal VBBQM that has passed through driver circuit 1102 is supplied at node B2 and is unconverted to a higher frequency signal VRFM on line 1106 (note that node B2 is a copy of VBBQM because transistor 1002 and 1006 in the driver circuit 1102 are source followers). In this arrangement, the transistor 404 is turned off thereby preventing the baseband input signal VBBQP that has passed through driver circuit 1101 to node B1 from shorting with the signal VRFM.

Similarly, when the transistors 404, 406 are turned on and 402, 408 are turned off, the baseband input signal VBBQM at node B2 is prevented from shorting with the signal VRFM and the baseband input signal VBBQP at node B1 is prevented from shorting with the signal VRFP.

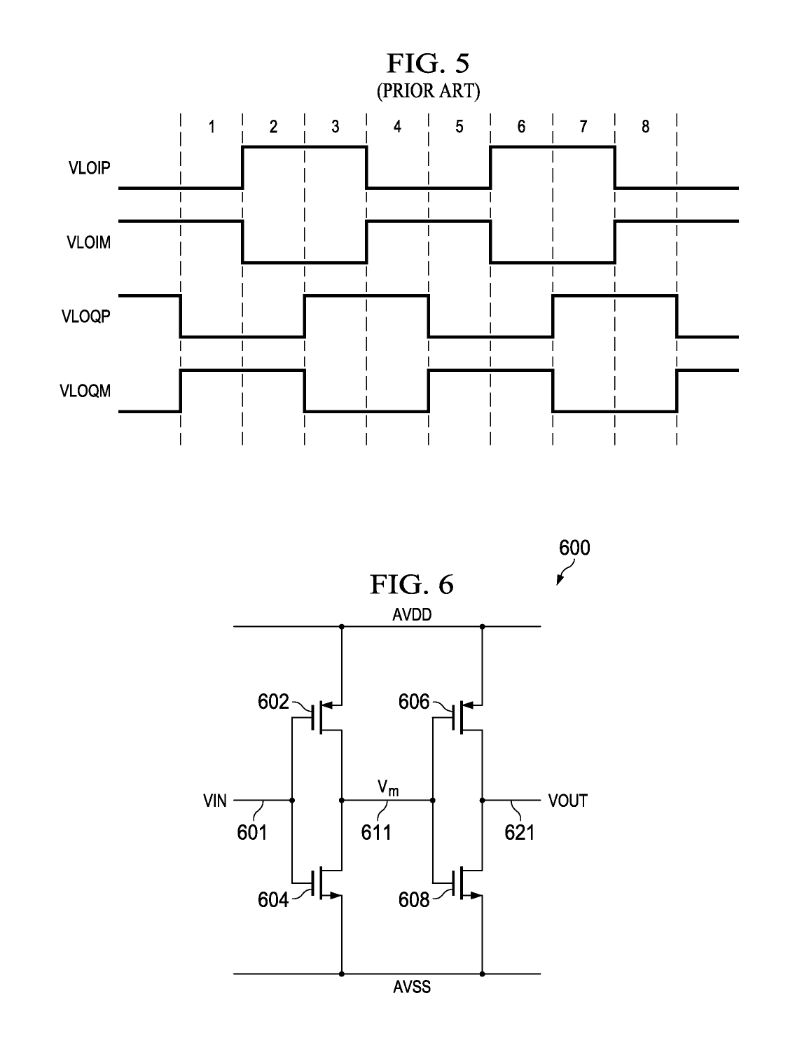

As a result, the baseband driver circuits 1101 and 1102 have less distortion and also less current consumption than if the IQ passive mixer 400 received the local oscillator signals shown in FIG. 5. Thus the IQ passive mixer 400 may achieve higher gain and higher linearity. It will be appreciated that the bottom half of the IQ passive mixer circuit 400 (not shown in FIG. 11) will receive the baseband input signals VBBIP and VBBIM through driver circuits equivalent to driver circuit 1000 and will receive local oscillator signals VLOQP and VLOQM that will have the same shape as, but will lag by 90 degrees, the waveforms shown in FIG. 8. Thus VBBIP and VBBIM will be prevented from shorting on the output line 1104 and on the output line 1106.

Whilst the driver circuit 1000 has been described using NMOS transistors, it will be appreciated that source follower transistors 1002, 1006 and bias transistors 1004, 1008 may be PMOS devices.

While this invention has been particularly shown and described with reference to certain embodiments, it will be understood to those skilled in the art that various changes in form and detail may be made without departing from the scope of the invention as defined by the appendant claims

What is claimed is:

1. An apparatus for generating complementary periodic signals for a mixer circuit, the apparatus comprising:
first and second generation circuits each for generating a periodic signal with a transition time on each rising edge different than a transition time on each falling edge, each circuit having an output for supplying its periodic signal to a mixer such that each rising edge of a periodic signal from one of the circuits crosses each falling edge of a periodic signal from the other of the circuits at a crossing point below a turn on voltage of the mixer.

2. The apparatus according to claim 1, wherein the transition time of each rising edge is slower than the transition time of each falling edge.

3. The apparatus according to claim 1, wherein each of the first and second generation circuits comprise a first CMOS inverter and a second CMOS inverter connected in series.

4. The apparatus according to claim 3, wherein the first CMOS inverters of the first and second generation circuits are each configured to receive a square wave, the square waves having equal amplitude and opposite phase.

5. The apparatus according to claim 3, wherein the first CMOS inverter comprises a PMOS and NMOS transistor of different sizes connected in series,; and
the second CMOS inverter comprises a PMOS and NMOS transistor of different sizes connected in series.

6. The apparatus according to claim 5, wherein the PMOS transistor of the first CMOS inverter has a larger channel width than the NMOS transistor of the first CMOS inverter and the NMOS transistor of the second CMOS inverter has a larger channel width than the PMOS transistor of the second CMOS inverter.

7. The apparatus according to claim 5, wherein the PMOS transistor of the first CMOS inverter has a smaller channel length than the NMOS transistor of the first CMOS inverter and the NMOS transistor of the second CMOS inverter has a smaller channel length than the PMOS transistor of the second CMOS inverter.

8. The apparatus according to claim 1, wherein the first and second generation circuits are connected between upper and lower voltage supply rails, the crossing point being below the midpoint of the voltages.

9. A method of generating complementary periodic signals for a mixer, the method comprising:
generating first and second periodic signals with a transition time on each rising edge different than a transition time on each falling edge, from each of a first and second generation circuit;
supplying the first periodic signal at a first output for connection to the mixer; and
supplying the second periodic signal at a second output for connection to the mixer, such that each rising edge at the first output is timed to cross each falling edge at the second output at a crossing point below a turn on voltage of the mixer.

10. A CMOS passive mixer comprising a first and second transistor, the CMOS passive mixer further comprising:
first and second generation circuits each for generating a periodic signal with a transition time on each rising edge different than a transition time on each falling edge, each circuit having an output for supplying its periodic signal to a mixer such that each rising edge of a periodic signal from one of the circuits crosses each falling edge of a periodic signal from the other of the circuits at a crossing point below a turn on voltage of the mixer;
wherein the periodic signal from the first generation circuit controls the first transistor and the periodic signal from the second generation circuit controls the second transistor such that only one of the first and second transistors is turned on at any one time.

11. The CMOS passive mixer according to claim 10, wherein the first and second transistors in the CMOS passive mixer are native transistors.

12. The CMOS passive mixer according to claim 10, wherein the periodic signals from the first and second generation circuits are each at a mixing frequency of the mixer.

13. The CMOS passive mixer according to claim 10, wherein the first and second transistors are arranged to receive an output signal from a driver circuit, the driver circuit comprising:
a first circuit branch having first and second circuit components arranged to receive respectively an input signal and a bias signal;
a second circuit branch having first and second circuit components, the first component arranged to receive the input signal; and
an operational amplifier having a first input connected to a junction node of the first and second circuit components of the first circuit branch and a second input connected to a junction node of the first and second circuit components of the second circuit branch, the operational amplifier arranged to provide an operational amplifier output signal to the second component of the second circuit branch so that a voltage at the junction node of the second circuit branch is equal to a voltage at the junction node of the first circuit branch, said voltage dependent on said input signal and providing said drive signal.

14. A CMOS passive mixer according to claim 10, wherein the first and second transistors are arranged to receive an output signal from a driver circuit, the driver circuit having first and second circuit components arranged to receive respectively an input signal and a bias input signal and supply the output signal to the first and second transistors via a resistor.

15. A CMOS passive mixer according to claim 13, wherein the input signal is a baseband input signal.

16. A CMOS passive mixer according to claim 14, wherein the input signal is a baseband input signal.
